(19) United States
(12) Patent Application Publication
(10) Pub. No.: US 2009/0046047 A1
(43) Pub. Date: Feb. 19, 2009

(54) SOURCE DRIVING APPARATUS

(75) Inventor: Jin-Sheng Hsieh, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/933,369

(22) Filed: Oct. 31, 2007

(30) Foreign Application Priority Data
Aug. 13, 2007 (TW) 96129852

(51) Int. Cl. G09G 3/36

(52) U.S. Cl. 345/98

(57) ABSTRACT

A source driving apparatus is disclosed. The source driving apparatus of the present invention is capable enough of driving all pixels in an LCD panel without extremely enhancing the driving capability of the buffers therein to suit an increasing total channel number thereof mainly by means of a novel wiring manner for connecting a plurality of first switches, a plurality of second switches, a plurality of first connection lines and a plurality of second connection lines.

### CROSS-REFERENCE TO RELATED APPLICATION

This application claims the priority benefit of Taiwan application serial no. 96129852, filed on Aug. 13, 2007. All disclosure of the Taiwan application is incorporated herein by reference.

### BACKGROUND OF THE INVENTION

1. Field of the Invention

The present invention generally relates to a source driving apparatus of a liquid digital display (LCD), and more particularly, to a source driving apparatus capable of driving all pixels in an LCD panel without extremely enhancing the driving capability of the buffers therein to suit an increasing total channel number thereof.

2. Description of Related Art

In the past years, in order to meet the higher and higher demand of the people on the display quality of an LCD, the high quality of LCD pixels has driven the related manufactures to advance the LCD panel resolution so as to satisfy the people with visual pleasure.

FIG. 1 is a circuit diagram of a conventional source driving apparatus 100. Referring to FIG. 1, assuming a source driving apparatus 100 in FIG. 1 has a total channel number of 200 and the gray level resolution of the corresponding LCD panel is 6-bits, the source driving apparatus 100 includes 63 resistors R₁-R₆₃, 64 buffers OPB₁-OPB₆₄, 64 connection lines L[1]-L[64] and 200 analog multiplexers MUX₁-MUX₂₀₀. The 63 resistors R₁-R₆₃ in series connection to each other form a voltage-dividing circuit coupled between a system voltage VDD and a ground level for providing 64 driving voltages V[0]-V[63] in different voltage levels. The buffers OPB₁-OPB₆₄ are used for respectively buffering the driving voltages V[0]-V[63], and then outputting the buffered driving voltages V[0]-V[63] to the corresponding connection lines L[1]-L[64].

Each of the analog multiplexers MUX₁-MUX₂₀₀ has 64 input terminals, a selection terminal and an output terminal, wherein the 64 input terminals of each of the analog multiplexers MUX₁-MUX₂₀₀ respectively and correspondingly receive one of the above-mentioned buffered driving voltages V[0]-V[63] through one of the connection lines L[1]-L[64]. Each of the analog multiplexers MUX₁-MUX₂₀₀ would output one of the above-mentioned buffered driving voltages V[0]-V[63] via the output terminal according to a selection code S_{0/1/2/ . . . /399}[5:0], which is provided by a plurality of latches (not shown) in 6-bit number size and received by the selection terminal, so as to drive the corresponding pixel in the LCD panel (not shown).

When the source driving apparatus 100 is used for displaying a mono color with an applicable LCD, all the analog multiplexers MUX₁-MUX₂₀₀ would select the same driving voltages V[0]-V[63] to output, for example, a driving voltage V[0]; at the time, the buffer OPB₁ must have sufficient capability to drive all the pixels in the LCD panel such that the buffer OPB is able to boost all the pixel of the LCD panel to an appropriate voltage level in a required time duration. Therefore, in the prior art, enhancing the driving capability of the buffers OPB₁-OPB₆₄ is one of the inevitable solutions.

The total channel number of the source driving apparatus 100 is increased with the increasing resolution of an LCD panel. Therefore, the driving capability of the buffers OPB₁-OPB₆₄ must be accordingly enhanced to meet the required time demand in which all the pixels of the LCD panel are boosted to appropriate voltage levels. This would enhance the driving capability, but on the other hand, this would also increase the occupied area of the buffers OPB₁-OPB₆₄ and moreover cause additional consumption of static/dynamic currents with the buffers OPB₁-OPB₆₄ leading degraded operation stability thereof.

### SUMMARY OF THE INVENTION

Accordingly, one objective of the present invention is to provide a source driving apparatus capable of driving all pixels in an LCD panel without extremely enhancing the driving capability of the buffers therein to suit an increasing total channel number thereof.

The present invention is also directed to am LCD having the above-mentioned source driving apparatus provided by the present invention.

According to the claims of the present invention, the present invention provides a source driving apparatus which includes a driving voltage generating unit, a plurality of analog multiplexers and a control unit. The driving voltage generating unit is for providing N driving voltage levels, wherein N is a positive integer. The analog multiplexers are divided into a first group of analog multiplexers and a second group of analog multiplexers, and each of the analog multiplexer has a plurality of input terminals for correspondingly receiving the above-mentioned N driving voltage levels, at least a selection terminal and an output terminal, wherein each of the analog multiplexer would select and use the output terminal thereof to output one of the above-mentioned N driving voltage levels according to a selection code received by the selection terminal thereof for outputting the same from the output terminal thereof.

The control unit is coupled to the analog multiplexers, wherein when both at least an analog multiplexer in the first group and at least an analog multiplexer in the second group select a first driving voltage level. The control unit controls at least the analog multiplexer in the first group and at least the analog multiplexer in the second group to respectively output different driving voltage levels in a first period, and then controls at least the analog multiplexer in the first group and at least the analog multiplexer in the second group simultaneously output the first driving voltage level in a second period.

In several embodiments of the present invention, the driving voltage generating unit includes (N−1) resistors in series connection to each other and N or (N−1) buffers, wherein the resistors are coupled between a system voltage and a reference level for dividing a level difference between the system voltage and the reference level and generating the above-mentioned N driving voltage levels. The above-mentioned N or (N−1) buffers are mainly for respectively buffering the above-mentioned N driving voltage levels and then outputting the buffered driving voltage levels to the input terminals of each analog multiplexer.

In several embodiments of the present invention, the control unit is mainly composed of a plurality of first switches and second switches, a plurality of first connection lines and second connection lines and a plurality of latches, wherein the first switches and the second switches are connected to the first connection lines and the second connection lines in a particular wiring manner and further in association with the latches to realize the predetermined goal of the present invention.

In several embodiments of the present invention, the control unit is mainly composed of a plurality of digital logic gates, a plurality of latches and a plurality of connection lines, wherein the digital logic gates are for changing the selection codes of the latches to be provided to the selection terminals of the above-mentioned analog multiplexers so as to realize the predetermined goal of the present invention as well.

According to the above mentioned, the source driving apparatus of the present invention is capable enough of driving all pixels in an LCD panel without extremely enhancing the driving capability of the buffers therein to suit an increasing total channel number thereof by using either way of the above-mentioned two control unit architectures.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional source driving apparatus.

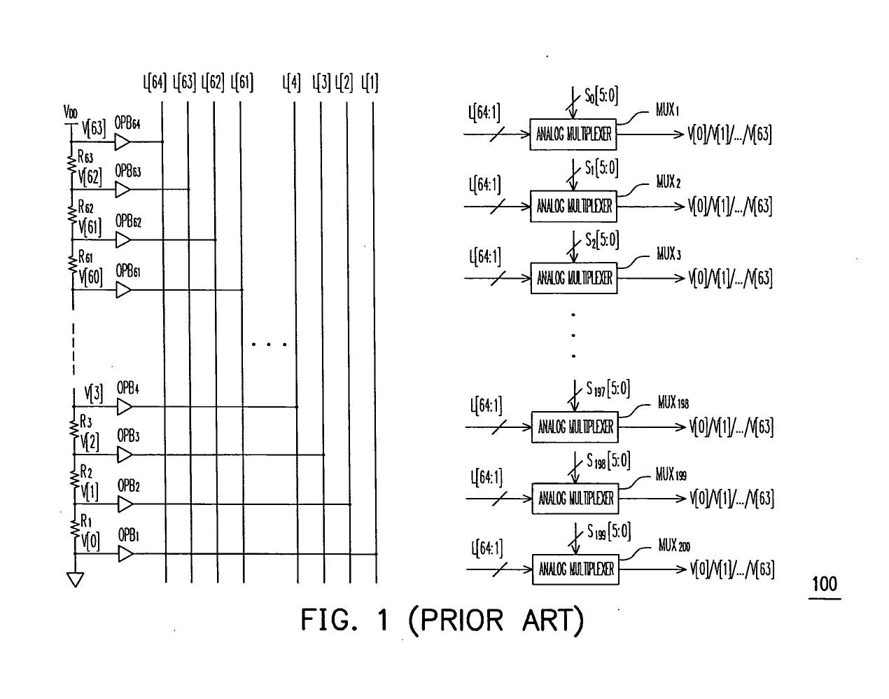

FIG. 2 is a circuit diagram of a source driving apparatus according to the first embodiment of the present invention.

FIG. 3 is a circuit diagram of a source driving apparatus according to the second embodiment of the present invention.

FIG. 4 is a circuit diagram of a source driving apparatus according to the third embodiment of the present invention.

FIG. 5 is a circuit diagram of a source driving apparatus according to the fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The technical goal to be achieve by the present invention mainly rests in that the provided source driving apparatus is capable of driving all pixels in an LCD panel without extremely enhancing the driving capability of the buffers therein to suit an increasing total channel number thereof. In the following, the technical features of the present invention are depicted for a reference to anyone skilled in the art.

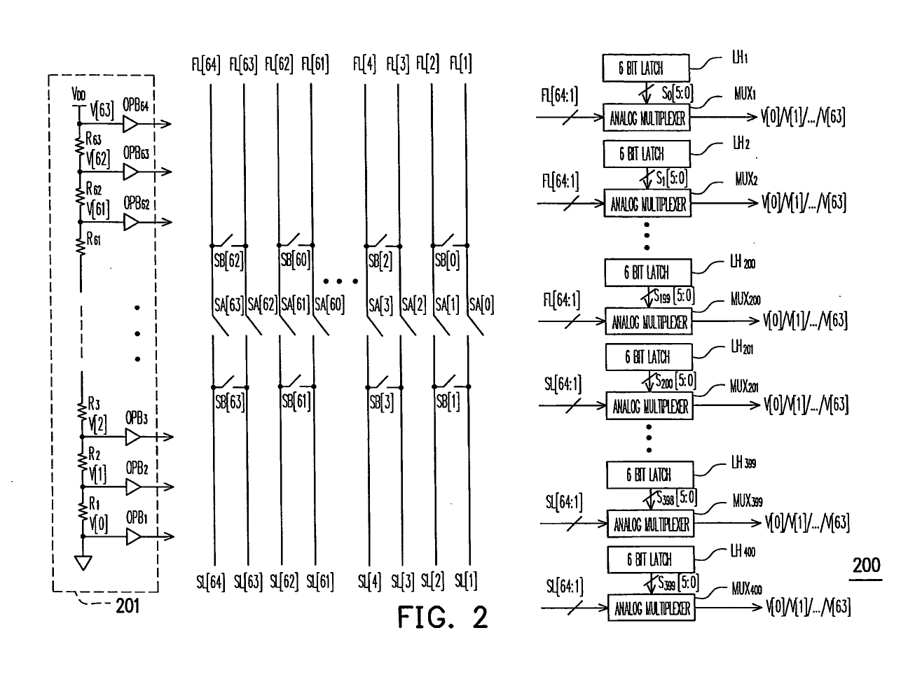

FIG. 2 is a circuit diagram of a source driving apparatus 200 according to the first embodiment of the present invention. Referring to FIG. 2, in order to better explain the spirit of the present invention for anyone skilled in the art to more clearly understand, as a first step, it is assumed that the total channel number of a source driving apparatus 200 in FIG. 2 is 400 and the gray level thereof has a 6-bit resolution. However, the assuming condition is mainly intended to better explain the present invention, not to limit the claim scope of the present invention.

The source driving apparatus 200 includes a driving voltage generating unit 201, 400 analog multiplexers MUX₁-MUX₄₀₀, and a control unit. In the first embodiment, the driving voltage generating unit 201 includes 63 resistors R₁-R₆₃ in series connection to each other and 64 buffers OPB₁-OPB₆₄, wherein the resistors R₁-R₆₃ are coupled between a system voltage VDD and a reference level (for example, a ground level) for dividing the level difference between the system voltage VDD and the reference level into 64 driving voltages V[0]-V[63]. The buffers OPB₁-OPB₆₄ are respectively utilized for respectively buffering the driving voltages V[0]-V[63] and then outputting the driving voltages V[0]-V[63], wherein the driving capabilities of the buffers OPB₁-OPB₆₄ in the driving voltage generating unit 201 are nearly the same as driving capabilities of the buffers OPB₁-OPB₆₄ in the conventional source driving apparatus 100.

The analog multiplexers MUX₁-MUX₄₀₀ are divided into a first group including analog multiplexers MUX₁-MUX₂₀₀ and a second group including analog multiplexers MUX₂₀₁-MUX₄₀₀. Each of the analog multiplexers MUX₁-MUX₄₀₀ has 64 input terminals for correspondingly receiving the above-mentioned 64 buffered driving voltages V[0]-V[63], a selection terminal and an output terminal. Each of the analog multiplexers MUX₁-MUX₄₀₀ would select one of the 64 driving voltages V[0]-V[63] for outputting via the output terminal thereof according to a selection code S_{0/1/2/ . . . /399}[5:0] respectively received by the selection terminal thereof.

In the prior art, since the driving capability of each of the buffers OPB₁-OPB₆₄ is capable of driving 200 analog multiplexers only, thus, if over 200 analog multiplexers among the 400 analog multiplexers MUX₁-MUX₄₀₀ select a same driving voltage, the buffer corresponding to the selected driving voltage encounters a driving difficulty. Note that in the embodiment, all the analog multiplexers MUX₁-MUX₄₀₀ are assumed to select a same driving voltage for simplifying the depiction of the present invention to outstandingly show up the advantages thereof.

When all the analog multiplexers MUX₁-MUX₄₀₀ select the output of the first driving voltage among the above-mentioned 64 buffered driving voltages V[0]-V[63], for example, the buffered driving voltage V[0], the control unit would enable the analog multiplexers MUX₁-MUX₂₀₀ of the first group and the analog multiplexers MUX₂₀₁-MUX₄₀₀ of the second group to respectively output different driving voltage among the above-mentioned 64 buffered driving voltages V[0]-V[63] in the first period. After that, the control unit would enable the analog multiplexers MUX₁-MUX₂₀₀ of the first group and the analog multiplexers MUX₂₀₁-MUX₄₀₀ of the second group to simultaneously output the first driving voltage V[0] in the second period. In the embodiment, in the first period, the analog multiplexers MUX₁-MUX₂₀₀ of the first group would select the buffered driving voltage V[0] to output, while the analog multiplexers MUX₂₀₁-MUX₄₀₀ of the second group would select the buffered driving voltage V[1] to output.

In order to make the control unit of the source driving apparatus 200 realize the predetermined goal, in the first embodiment, the control unit of the source driving apparatus 200 is coupled to the buffers OPB₁-OPB₆₄ and the analog multiplexers MUX₁-MUX₄₀₀ and includes 64 first connection lines FL[1]-FL[64], 64 second connection lines SL[1]-SL[64], 64 first switches SB[1]-SB[64], 64 second switches SA[1]-SA[64] and 400 6-bit latches LH₁-LH₄₀₀, wherein the latches LH₁-LH₄₀₀ are respectively coupled to the selection terminals of the analog multiplexers MUX₁-MUX₄₀₀ for respectively providing selection codes S_{0/1/2/ . . . 399}[5:0] to correspondingly analog multiplexers MUX₁-MUX₄₀₀, so that each of the analog multiplexers MUX₁-MUX₄₀₀ is able to select one of the above-mentioned 64 buffered driving voltages V[0]-V[63] for outputting via the output terminal thereof.

The odd ones of the first connection lines FL[1], FL[3], . . . ,FL[63] are respectively coupled to the odd input terminals of the analog multiplexers MUX₁-MUX₂₀₀ of the first group for correspondingly receiving the buffered driving voltages V[0], V[2], . . . ,V[62] from the odd buffers OPB₁, OPB₃, . . . ,OPB₆₃; the even ones of the first connection lines FL[2], FL[4], . . . ,FL[64] are floating and respectively coupled to the even input terminals of the analog multiplexers MUX₁-MUX₂₀₀ of the first group.

Similarly, the even ones of the second connection lines SL[2], SL[4], . . . ,SL[64] are respectively coupled to the even input terminals of the analog multiplexers MUX₂₀₁-MUX₄₀₀ of the second group for correspondingly receiving the buffered driving voltages V[l], V[3], . . . ,V[63] from the even buffers OPB₂, OPB₄, . . . ,OPB₆₄; the odd ones of the second connection lines SL[1], SL[3], . . . ,SL[63] are floating and respectively coupled to the odd input terminals of the analog multiplexers MUX₂₀₁-MUX₄₀₀ of the second group.

The first switches SB[0]-SB[63] are divided into a third group including the first switches SB[0], SB[2], . . . ,SB[60], SB[62] and a fourth group including the first switches SB[1], SB[3], . . . ,SB[61], SB[63]. It can be seen clearly from FIG. 2 that the first switches SB[0], SB[2], . . . ,SB[60], SB[62] of the third group are respectively coupled between the i-th one and the (i+1)-th one of all the first connection lines FL[1]-FL[64], while the first switches SB[1], SB[3], . . . ,SB[59], SB[61] of the fourth group are respectively coupled between the i-th one and the (i+1)-th one of all the second connection lines SL[1]-SL[64], where i is an odd positive integer.

For example, the first switch SB[0] is coupled between the first one of the first connection lines, i.e. FL[1] and the second one of the first connection lines, i.e. FL[2]; the first switch SB[2] is coupled between the third one of the first connection lines, i.e. FL[3] and the fourth one of the first connection lines, i.e. FL[4]; the first switch SB[1] is coupled between the first one of the second connection lines, i.e. SL[1] and the second one of the second connection lines, i.e. SL[2]; the first switch SB[3] is coupled between the third one of the second connection lines, i.e. SL[3] and the fourth one of the second connection lines, i.e. SL[4], and analogically for the rest.

The second switches SA[0]-SA[63] are respectively coupled between the j-th one of all the first connection lines FL[1]-FL[64] and the j-th one of all the second connection lines SL[1]-SL[64], where j is a positive integer. For example, the second switch SA[0] is coupled between the first one of the first connection lines, i.e. FL[1] and the first one of the second connection lines, i.e. SL[1]; the second switch SA[1] is coupled between the second one of the first connection lines, i.e. FL[2] and the second one of the second connection lines, i.e. SL[2], and analogically for the rest.

In the first embodiment, the first switches SB[0]-SB[63] are turned on in the first period, the second switches SA[0]-SA[63] are turned on in the second period, and in this way, one of both the analog multiplexers MUX₁-MUX₂₀₀ of the first group and the analog multiplexers MUX₂₀₁-MUX₄₀₀ of the second group outputs a driving voltage in the first period differing somewhat from the predetermined driving voltage.

For example, assuming all the analog multiplexers MUX₁-MUX₄₀₀ select a same buffered driving voltage V[0], the 6-bit latches LH₁-LH₄₀₀ would respectively provide the selection codes S_{0/1/2/ . . . /399}[5:0] taking a binary number of 000000B to the selection terminals of the analog multiplexers MUX₁-MUX₄₀₀, so that all the analog multiplexers MUX₁-MUX₄₀₀ would select the driving voltage received by the first input terminals thereof as the output thereof.

However, as the above mentioned, the first switches SB[0]-SB[63] of the control unit are turned on in the first period, the second switches SA[0]-SA[63] of the control unit are turned off in the first period; thus, the first connection lines FL[1] and FL[2] are connected to each other and the second connection lines SL[1] and SL[2] are connected to each other, so that the first input terminals of the analog multiplexers MUX₁-MUX₂₀₀ of the first group would receive the driving voltage V[0] via the first connection line FL[1] and the output terminals of all the analog multiplexers MUX₁-MUX₂₀₀ output the driving voltage V[0]. The above-mentioned situation means the buffer OPB₁ would drive a part of all the pixels in the LCD panel (not shown) in the first period, wherein the pixels of the part are correspondingly coupled the output terminals of all the analog multiplexers MUX₁-MUX₂₀₀.

On the other hand, the first input terminals of the analog multiplexers MUX₂₀₁-MUX₄₀₀ of the second group would receive the driving voltage V[1] via the second connection line SL[2] and the output terminals of all the analog multiplexers MUX₂₀₁-MUX₄₀₀ of the second group output the driving voltage V[1]. The above-mentioned situation means the buffer OPB₂ would drive a part of all the pixels in the LCD panel in the first period, wherein the pixels of the part are correspondingly coupled to the output terminals of all the analog multiplexers MUX₂₀₁-MUX₄₀₀.

Further, the first switches SB[0]-SB[63] of the control unit are turned off in the second period, the second switches SA[0]-SA[63] of the control unit are turned on in the second period; thus, the first connection line FL[1] and second connection line SL[1] are connected to each other, so that the first input terminals of the analog multiplexers MUX₁-M₄₀₀ would receive the driving voltage V[0] via the first connection line FL[1], which makes the output terminals of the analog multiplexers MUX₁-MUX₄₀₀ output the driving voltage V[0]. The above-mentioned situation means the buffer OPB₁ would drive all the pixels in the LCD panel in the second period.

Similarly, assuming all the analog multiplexers MUX₁-M₄₀₀ select a same buffered driving voltage V[1], the 6-bits latches LH₁-LH₄₀₀ would respectively provide the selection code S_{0/1/2/ . . . /399}[5:0] taking a binary number of 000001B to the selection terminals of the analog multiplexers MUX₁-MUX₄₀₀, so that all the analog multiplexers MUX₁-MUX₄₀₀ would select the driving voltage received by the second input terminals thereof as the output thereof.

However, as the above mentioned, the first switches SB[0]-SB[63] of the control unit are turned on in the first period, the second switches SA[0]-SA[63] of the control unit are turned off in the first period; thus, the first connection lines FL[1] and FL[2] are connected to each other and the second connection lines SL[1] and SL[2] are connected to each other, so that the second input terminals of the analog multiplexers MUX₁-MUX₂₀₀ of the first group would receive the driving voltage V[0] via the first connection line FL[1] and the output terminals of all the analog multiplexers MUX₁-MUX₂₀₀ output the driving voltage V[0], which enables the buffer OPB₁ to drive a part of all the pixels of the LCD panel in the first period, wherein the pixels of the part are correspondingly coupled to the output terminals of all the analog multiplexers MUX₁-MUX₂₀₀.

On the other hand, the second input terminals of the analog multiplexers MUX₂₀₁-MUX₄₀₀ of the second group would receive the driving voltage V[1] received by the second connection line SL[2] and the output terminals of all the analog multiplexers MUX₂₀₁-MUX₄₀₀ of the second group output the driving voltage V[1], which enables the buffer OPB₂ to drive a part of all the pixels of the LCD panel in the first period, wherein the pixels of the part are correspondingly coupled to the output terminals of all the analog multiplexers MUX₂₀₁-MUX₄₀₀.

Furthermore, the first switches SB[0]-SB[63] of the control unit are turned off in the second period, the second switches SA[0]-SA[63] of the control unit are turned on in the second period; thus, the first connection line FL[1] and second connection line SL[1] are connected to each other, so that the second input terminals of the analog multiplexers MUX₁-MUX₄₀₀ would receive the driving voltage V[1] received by the second connection line SL[2], which enables the output terminals of the analog multiplexers MUX₁-MUX₄₀₀ to output the driving voltage V[1], and the buffer OPB₂ would drive all the pixels in the LCD panel in the second period.

In addition, in the first embodiment, assuming all the analog multiplexers MUX₁-MUX₄₀₀ select other buffered driving voltage for outputting, for example, V[2], V[3], . . . ,or V[63], the corresponding operation is the same as the above-mentioned situation of selecting the driving voltage V[0] or V[1]. This could be easily deducted by anyone skilled in the art and is omitted for simplicity herein.

It is clear from the above-mentioned examples that when all the analog multiplexers MUX₁-MUX₄₀₀ select and output the buffered driving voltage V[0] or V[1], all the pixels in the LCD panel are not fully driven by a buffer OPB₁ or OPB₂ indicated by the prior art; in the embodiment, for the first period, the buffers OPB₁ and OPB₂ are simultaneously used to respectively drive a half of all the pixels in the LCD panel, while for the second period, the buffer OPB₁ or OPB₂ is used to drive all the pixels in the LCD panel. Since the voltage difference between the two buffered driving voltages V[0] and V[1] is not large, thus, the buffer OPB₁ or OPB₂ is not necessary to particularly enhance the driving capability thereof and still capable enough of driving all the pixels in the LCD panel in the second period.

According to the above-mentioned mechanism, when the number of analog multiplexers corresponding to a same gray level (for example, a same color) exceeds the number of pixels that a single buffer is capable of driving, the source driving apparatus 200 of the present invention is able to utilize two buffers therein to respectively drive a part of the channels corresponding to the gray level of the LCD panel in the first period, and then utilize a single buffer to drive all the channels corresponding to the gray level of the LCD panel in the second period. In this way, when the total channel number of the source driving apparatus 200 of the first embodiment is double of the total channel number of the conventional source driving apparatus 100, the source driving apparatus 200 is competent for driving all the pixels in the LCD panel without enhancing the driving capabilities of the buffers OPB₁-OPB₆₄ therein.

Besides, the number of the employed analog multiplexers and the number of the employed latches in the source driving apparatus 200 must follow the total channel number of the source driving apparatus 200, while the number of the employed resistors and the number of the employed buffers in the driving voltage generating unit 201, and the numbers of the employed first switches, second switches, first connection lines and second connection lines in the control unit mainly depend on the gray level resolution of the source driving apparatus 200, which should be easily deducted by anyone skilled in the art and omitted herein for simplicity.

Note that the above-mentioned source driving apparatus 200 is corresponding to, not limiting the present invention, one of embodiments of the present invention, i.e. the first embodiment. In other to clearly describe the present invention, the source driving apparatus 200 may employ more buffers so as to respectively drive the pixels of the LCD panel in the first period, and then use a single buffer to drive all the pixels of the PCD panel in the second period.

Although in the first embodiment, two adjacent buffers are exemplarily used to depict the present invention, but it does not mean the present invention is limited thereto. In other words, a user is allowed to modify the wiring manner between the first and second switches and the first and second connection lines of the control unit described hereinbefore, and use other buffers (for example, not-adjacent buffers) for driving, which still falls within the claimed scope of the present invention.

In the above-mentioned examples, since the driving voltage V[1] is greater than the driving voltage V[0], the output terminals of the analog multiplexers MUX₂₀₁-MUX₄₀₀ of the second group would output the driving voltage V[1] in the first period, following by outputting the driving voltage V[0] in the second period, which may not only require a half of all the pixels in the LCD panel must discharge the excessive charges in the second period, but also increase the electric consumption of the source driving apparatus 200. To solve the potential problem of the source driving apparatus 200 in the first embodiment, the present invention further provides another source driving apparatus.

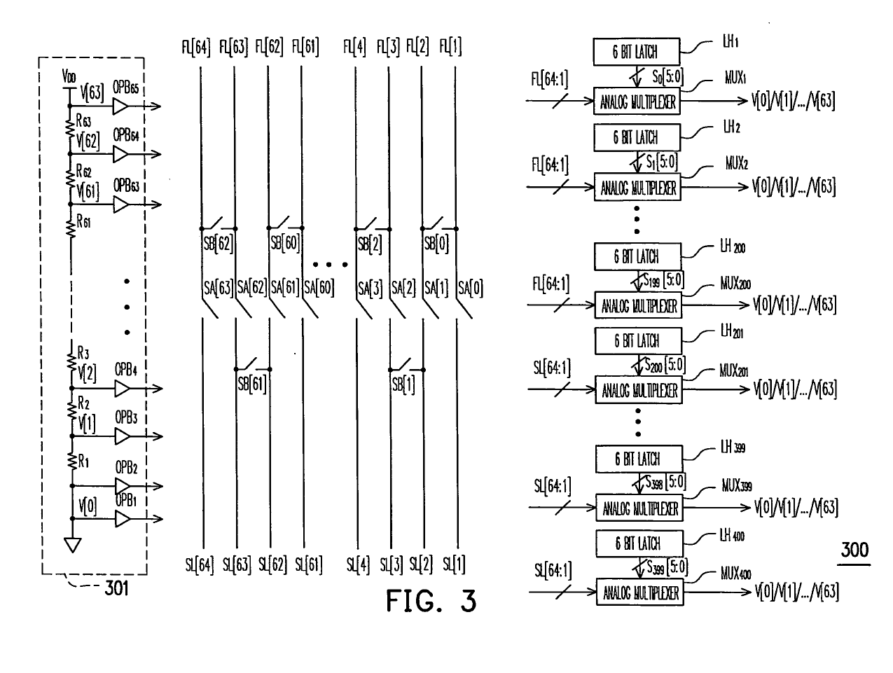

FIG. 3 is a circuit diagram of a source driving apparatus 300 according to the second embodiment of the present invention. Referring to FIG. 3, assuming the total channel number of the source driving apparatus 300 is 400 and the resolution of the gray level thereof is 6-bits; accordingly, the source driving apparatus 300 of the second embodiment includes a driving voltage generating unit 301, 400 analog multiplexers MUX₁-MUX₄₀₀ and a control unit.

In the second embodiment, the structure of the driving voltage generating unit 301 is similar to the driving voltage generating unit 201 except that the driving voltage generating unit 301 has 65 buffers OPB₁-OPB₆₅ for respectively driving the driving voltages V[0]-V[63] and then outputting the buffered driving voltages, wherein the buffers OPB₁ and OPB₂ are for buffering the driving voltage V[0], and the buffers OPB₁-OPB₆₅ of the driving voltage generating unit 301 have driving capabilities almost the same as the driving capabilities of the buffers OPB₁-OPB₆₄ of the conventional source driving-apparatus 100.

The analog multiplexers MUX₁-MUX₄₀₀ of the source driving apparatus 300 have the same structures and function as the analog multiplexers MUX₁-MUX₄₀₀ of the source driving apparatus 200, thus they are omitted to describe for simplicity. Besides, the structure of the control unit of the source driving apparatus 300 has minor difference from the one of the source driving apparatus 200, but the minor difference is so significant for the source driving apparatus 300 to solve the disadvantage of the source driving apparatus 200.

In the second embodiment, the control unit of the source driving apparatus 300 is coupled to the buffers OPB₁-OPB₆₅ and the analog multiplexers MUX₁-MUX₄₀₀ and includes 64 first connection lines FL[1]-FL[64], 64 second connection lines SL[1]-SL[64], 63 first switches SB[0]-SB[62], 64 second switches SA[0]-SA[63] and 400 6-bit latches LH₁-LH₄₀₀, wherein the latches LH₁-LH₄₀₀ of the source driving apparatus 300 have the same structures and functions as the ones of the source driving apparatus 200, thus they are omitted to describe for simplicity.

The odd ones of the first connection lines FL[l], FL[3], . . . ,FL[63] are respectively coupled to the odd input terminals of the analog multiplexers MUX₁-MUX₂₀₀ of the first group for correspondingly receiving the buffered driving voltages V[0], V[2], . . . ,V[62] from the even buffers OPB₂, OPB₄, . . . , OPB₆₄; the even ones of the first connection lines FL[2], FL[4], . . . ,FL[64] are floating connection and respectively coupled to the even input terminals of the analog multiplexers MUX₁-MUX₂₀₀ of the first group.

The first one of the second connection lines SL[1] and the even ones of the second connection lines SL[2], SL[4], . . . ,SL[64] are for correspondingly receiving the buffered driving voltages V[0], V[1], . . . , V[61] and V[63] from the odd buffers OPB₁, OPB₃, . . . , OPB₆₅, wherein the first one of the second connection lines SL[1] is coupled to the first input terminals of the analog multiplexers MUX₂₀₁-MUX₄₀₀ of the second group, while the even ones of the second connection lines SL[2], SL[4], . . . , L[64] are respectively coupled to the even input terminals of the analog multiplexers MUX₂₀₁-MUX₄₀₀ of the second group. In addition, the odd ones of the second connection lines SL[1], SL[3], . . . ,L[63] but except for the first one of the second connection lines SL[ 1] are floating, and the rest odd ones of the second connection lines SL[3], SL[5], . . . , SL[63] are respectively coupled to the odd input terminals of the analog multiplexers MUX₂₀₁-MUX₄₀₀ of the second group.

The first switches SB[0]-SB[62] are divided into a third group including the first switches SB[0], SB[2], . . . ,SB[60], SB[62] and a fourth group including the first switches SB[1], SB[3], . . . ,SB[61]. It can be seen clearly from FIG. 3 that the first switches SB[0], SB[2], . . . ,SB[60], SB[62] of the third group are respectively coupled between the i-th one and the (i+1)-th one of all the first connection lines FL[1]-FL[64], while the first switches SB[1], SB[3], . . . ,SB[61] of the fourth group are respectively coupled between the j-th one and the (j+1)-th one of all the second connection lines SL[1]-SL[64], where i is an odd positive integer and j is a even positive integer.

For example, the first switch SB[0] is coupled between the first one of the first connection lines, i.e. FL[1] and the second one of the first connection lines, i.e. FL[2]; the first switch SB[2] is coupled between the third one of the first connection lines, i.e. FL[3] and the fourth one of the first connection lines, i.e. FL[4], and analogically for the rest; the first switch SB[1] is coupled between the second one of the second connection lines, i.e. SL[2] and the third one of the second connection lines, i.e. SL[3]; the first switch SB[3] is coupled between the fourth one of the second connection lines, i.e. SL[4] and the fifth one of the second connection lines, i.e. SL[5], and analogically for the rest.

The wiring relationship between the second switches SA[0]-SA[63] and the first and second connection lines FL[1]-FL[64] and SL[1]-SL[64] in FIG. 3 are the same as the wiring relationship between the second switches SA[0]-SA[63] and the first and second connection lines FL[1]-FL[64] and SL[1]-SL[64] in FIG. 2, so they are omitted to describe for simplicity.

Similarly, the first switches SB[0]-SB[62] are turned on in the first period, the second switches SA[0]-SA[63] are turned on in the second period, and in this way, one of both the analog multiplexers MUX₁-MUX₂₀₀ of the first group and the analog multiplexers MUX₂₀₁-MUX₄₀₀ of the second group outputs a driving voltage in the first period differing somewhat from the predetermined driving voltage, but the source driving apparatus 300 of the embodiment has eliminated the disadvantage of source driving apparatus 200 in the first embodiment.

For example, assuming all the analog multiplexers MUX₁-MUX₄₀₀ select a same buffered driving voltage V[0], the 6-bits latches LH₁-LH₄₀₀ would respectively provide the selection codes S_{0/1/2/ . . . /399}[5:0] having a binary number of 000000B to the selection terminals of the analog multiplexers MUX₁-MUX₄₀₀, so that all the analog multiplexers MUX₁-MUX₄₀₀ would select the driving voltage received by the first input terminals thereof as the output thereof.

However, as mentioned previously, the first input terminals of the analog multiplexers MUX₁-MUX₂₀₀ of the first group would receive the driving voltage V[0] received by the first connection line FL[ 1] in the first period and the second period; thus, and the output terminals of all the analog multiplexers MUX₁-MUX₂₀₀ of the first group output the driving voltage V[0] buffered by the buffer OPB₂ in the first period and the second period, which enables the buffer OPB₂ to drive a part of all the pixels in the LCD panel in the first period and the second period, wherein the pixels of the part are correspondingly coupled to the output terminals of all the analog multiplexers MUX₁-MUX₂₀₀

On the other hand, the first input terminals of the analog multiplexers MUX₂₀₁-MUX₄₀₀ of the second group would receive the driving voltage V[0] received by the second connection line SL[2] in the first period and the second period; thus, the output terminals of all the analog multiplexers MUX₂₀₁-MUX₄₀₀ of the second group output the driving voltage V[0] buffered by the buffer OPB₁ in the first period and the second period, which enables the buffer OPB₁ to drive a part of all the pixels in the LCD panel in the first period and the second period, wherein the pixels of the part are correspondingly coupled to the output terminals of all the analog multiplexers MUX₂₀₁-MUX₄₀₀.

When all the analog multiplexers MU_{X1}-MU_{X400} select the driving voltage V[0] buffered by the first buffer OPB₁ or the second buffer OPB₂, the source driving apparatus 300 would simultaneously utilize the buffers OPB₁ and OPB₂, to respectively drive a half ones and the rest half ones of all the pixels in the LCD panel in the first period and the second period. In this way, the buffers OPB₁ and OPB₂ are not necessary to enhance the driving capability thereof and still capable enough of driving all the pixels in the LCD panel in the first period and the second period.

Similarly, assuming all the analog multiplexers MUX₁-MUX₄₀₀ select a same buffered driving voltage V[ 1] for outputting, the 6-bit latches LH₁-LH₄₀₀ would respectively provide the selection codes S_{0/1/2/ . . . /399}[5:0] taking a binary number of 000001B to the selection terminals of the analog multiplexers MUX₁-MUX₄₀₀, so that all the analog multiplexers MUX₁-MUX₄₀₀ would select the driving voltage received by the second input terminals thereof as the output thereof.

However, as the above mentioned, the first switches SB[0]-SB[63] of the control unit are turned on in the first period, the second switches SA[0]-SA[63] of the control unit are turned off in the first period; thus, the first connection lines FL[1] and FL[2] are connected to each other and the second connection lines SL[1] and SL[2] are connected to each other, so that the second input terminals of the analog multiplexers MUX₁-MUX₂₀₀ of the first group would receive the driving voltage V[0] received by the first connection line FL[1] and the output terminals of all the analog multiplexers MUX₁-MUX₂₀₀ output the driving voltage V[0], which enables the buffer OPB₂ to drive a part of all the pixels of the LCD panel in the first period, wherein the pixels of the part are correspondingly coupled to the output terminals of all the analog multiplexers MUX₁-MUX₂₀₀.

On the other hand, the second input terminals of the analog multiplexers MUX₂₀₁-MUX₄₀₀ of the second group would receive the driving voltage V[1] received by the second connection line SL[2] and the output terminals of all the analog multiplexers MUX₂₀₁-MUX₄₀₀ of the second group output the driving voltage V[1], which enables the buffer OPB₃ to drive a part of all the pixels of the LCD panel in the first period, wherein the pixels of the part are correspondingly coupled to the output terminals of all the analog multiplexers MUX₂₀₁-MUX₄₀₀.

Furthermore, the first switches SB[0]-SB[62] of the control unit are turned off in the second period, the second switches SA[0]-SA[63] of the control unit are turned on in the second period; thus, the first connection line FL[2] and second connection line SL[2] are connected to each other, so that the second input terminals of the analog multiplexers MUX₁-MUX₄₀₀ would receive the driving voltage V[1] received by the second connection line SL[2], which enables the output terminals of the analog multiplexers MUX₁-MUX₄₀₀ to output the driving voltage V[1], and the buffer OPB₃ would drive all the pixels in the LCD panel in the second period.

Similarly, assuming all the analog multiplexers MUX₁-MUX₄₀₀ select the second driving voltage V[2] for outputting, at the time, the 6-bits latches LH₁,-LH₄₀₀ would respectively provide the selection codes S_{0/1/2/ . . . /399}[5:0] taking a binary number of 000010B to the selection terminals of the analog multiplexers MUX₁-MUX₄₀₀, which enables the analog multiplexers MUX₁-MUX₄₀₀ to select the driving voltage received by the third input terminals thereof for outputting.

However, as the above mentioned, the first switches SB[0]-SB[62] of the control unit are turned on in the first period, the second switches SA[0]-SA[63] of the control unit are turned off in the first period; thus, the first connection lines FL[3] and FL[4] are connected to each other and the second connection lines SL[2] and SL[3] are connected to each other, so that the third input terminals of the analog multiplexers MUX₁-MUX₂₀₀ of the first group would receive the driving voltage V[2] received by the first connection line FL[3] and the output terminals of all the analog multiplexers MUX₁-MUX₂₀₀ output the driving voltage V[2], which enables the buffer OPB₄ to drive a part of all the pixels of the LCD panel in the first period, wherein the pixels of the part are correspondingly coupled to the output terminals of all the analog multiplexers MUX₁-MUX₂₀₀.

On the other hand, the third input terminals of the analog multiplexers MUX₂₀₁-MUX₄₀₀ of the second group would receive the driving voltage V[1] received by the second connection line SL[2] and the output terminals of all the analog multiplexers MUX₂₀₁-MUX₄₀₀ of the second group output the driving voltage V[1], which enables the buffer OPB₃ to drive a part of all the pixels of the LCD panel in the first period, wherein the pixels of the part are correspondingly coupled to the output terminals of all the analog multiplexers MUX₂₀₁-MUX₄₀₀.

Furthermore, the first switches SB[0]-SB[62] of the control unit are turned off in the second period, the second switches SA[0]-SA[63] of the control unit are turned on in the second period; thus, the first connection line FL[3] and second connection line SL[3] are connected to each other, so that the third input terminals of the analog multiplexers MUX₁-MUX₄₀₀ would receive the driving voltage V[2] received by the first connection line FL[3], which enables the output terminals of the analog multiplexers MUX₁-MUX₄₀₀ to output the driving voltage V[2], and the buffer OPB₄ would drive all the pixels in the LCD panel in the second period.

In addition, in the second embodiment, assuming all the analog multiplexers MUX₁-MUX₄₀₀ select other buffered driving voltage for outputting, for example, V[3], V[4], . . . ,or V[63] for outputting, the corresponding operation is the same as the above-mentioned situation where the driving voltage V[1] or V[2] is output, which should be easily deducted by anyone skilled in the art with referring to the instruction of the second embodiment and is omitted for simplicity herein.

It is clear from the above-mentioned examples that when the number of the analog multiplexers to drive a same gray level exceeds the number of pixels which a single buffer is competent for driving, the source driving apparatus 300 of the present invention uses two buffers therein to respectively drive a part of all the channels of the LCD panel corresponding to the gray level in the first period, while in the second period, only a single buffer is used to drive all the channels of the part of the LCD panel corresponding to the gray level.

Consequently, even the total channel number of the source driving apparatus 300 of the second embodiment is double of the total channel number of the conventional source driving apparatus 100, the source driving apparatus 300 is competent for driving all the pixels in the LCD panel without enhancing the driving capabilities of the buffers OPB₁-OPB₆₅ therein.

In addition, it can be clearly seen from the second embodiment, no matter which of the driving voltage V[1]/V[2]/ . . . /V[63] is simultaneously selected by the analog multiplexers MUX₁-MUX₄₀₀ for outputting, the output terminals of the analog multiplexers MUX₁-MUX₄₀₀ are allowed to respectively output a driving voltage less then or equal to the predetermined driving voltage in the first period, following by outputting the predetermined driving voltages in the second period. As a result, the source driving apparatus 300 of the second embodiment eliminates the disadvantage of the first embodiment that the source driving apparatus 200 is required to discharge excessive charges.

Similarly, the number of the analog multiplexers and the number of the latches respectively required by the source driving apparatus 300 and the control unit thereof must follow the total channel number of the source driving apparatus 300, while the number of the employed resistors and the number of the employed buffers in the driving voltage generating unit 301, and the numbers of the employed first switches, second switches, first connection lines and second connection lines in the control unit mainly depend on the gray level resolution of the source driving apparatus 300, which should be easily deducted by anyone skilled in the art and omitted herein for simplicity.

According to the above disclosure, the source driving apparatuses 200 and 300 respectively provided by the first embodiment and the second embodiment mainly use a novel wiring manner for a plurality of first switches SB[0]-SB[63/62], a plurality of second switches SA[0]-SA[63], a plurality of first connection lines FL[1]-FL[64] and a plurality of second connection lines SL[1]-SL[64], so that the source driving apparatuses 200 and 300 are capable enough of driving all pixels in an LCD panel without extremely enhancing the driving capability of the buffers therein to suit an increasing total channel number thereof.

However, the circuit architectures of the source driving apparatuses 200 and 300 provided by the above-described first embodiment and the second embodiment are not to limit the present invention. The other source driving apparatuses having circuit architectures different from the ones of the source driving apparatuses 200 and 300 provided by the above-described first embodiment and the second embodiment are depicted in the following.

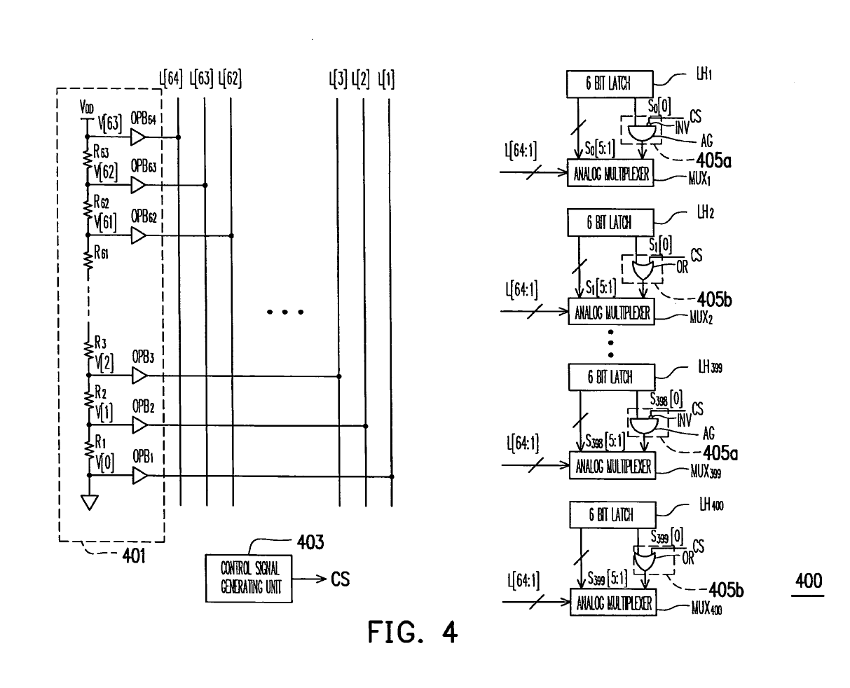

FIG. 4 is a circuit diagram of a source driving apparatus 400 according to the third embodiment of the present invention. Referring to FIG. 4, assuming the total channel number of the source driving apparatus 400 is 400 and the resolution of the gray level thereof is 6-bits; accordingly, the source driving apparatus 400 of the third embodiment includes a driving voltage generating unit 401, 400 analog multiplexers MUX₁-MUX₄₀₀ and a control unit. The electrical connections among the components and the function of the driving voltage generating unit 401 are almost the same as that of the driving voltage generating unit 201 and the analog multiplexers MUX₁-MUX₄₀₀ of the source driving apparatus 400 have the same structures and function as the analog multiplexers MUX₁-MUX₄₀₀ of the source driving apparatus 200, thus they are omitted to describe for simplicity.

The control unit of the source driving apparatus 400 is coupled to the buffers OPB₁-OPB₆₄ and the analog multiplexers MUX₁-MUX₄₀₀. The control unit of the source driving apparatus 400 includes 64 connection lines L[1]-L[64], 400 6-bits latches LH₁-LH₄₀₀, 200 first digital processing units 405a, 200 second digital processing units 405b and a control signal generating unit 403, wherein the connection lines L[1]-L[64] are respectively coupled to the input terminals of the analog multiplexers MUX₁-MUX₄₀₀ for correspondingly receiving the buffered driving voltages V[0]-V[63]. The latches LH₁-LH₄₀₀ of the source driving apparatus 400 have the same structures and function as the ones of the source driving apparatus 200, thus they are omitted to describe for simplicity.

The first digital processing units 405a are respectively coupled to the selection terminals of the analog multiplexers MUX₁, MUX₃, . . . ,MUX₃₉₉ for deciding whether or not to change the least-significant-bits (LSBs) of the selection codes S_{0/2/4/ . . . /398}[5:0] respectively received by the selection terminals of the analog multiplexers MUX₁, MUX₃ . . . ,MUX₃₉₉ in the first period according to a control signal CS provided by the control signal generating unit 403.

Similarly, the second digital processing units 405b are respectively coupled to the selection terminals of the analog multiplexers MUX₂, MUX₄, . . . ,MUX₄₀₀ for deciding whether or not to change the least-significant-bits (LSBs) of the selection codes S_{1/3/5/ . . . /399}[5:0] respectively received by the selection terminals of the analog multiplexers MUX₂, MUX₄, . . . ,MUX₄₀₀ in the first period according to a control signal CS provided by the control signal generating unit 403.

It can be clearly seen form FIG. 4, the first digital processing unit 405a mainly includes an AND-gate AG and an NOT-gate INV, while the second digital processing unit 405b mainly includes an OR-gate OR, and the electrical connections thereof can be referred to FIG. 4 and omitted herein for simplicity. Note that the control signal CS provided by the control signal generating unit 403 is enabled in the first period and disabled in the second period.

Accordingly, assuming all the analog multiplexers MUX₁-MUX₄₀₀ select a same driving voltage V[0] for outputting, at the time, the selection terminals of the analog multiplexers MUX₁-MUX₄₀₀ should respectively receive a binary number of 000001B of the selection codes S_{0/1/2/ . . . /399}[5:0] respectively provided by the latches LH₁-LH₄₀₀. However, since the control signal CS provided by the control signal generating unit 403 is enabled in the first period, therefore, the selection codes S_{0/2/4/ . . . /398}[5:0] respectively received by the selection terminals of all the odd analog multiplexers MUX₁, MUX₃, . . . ,MUX₃₉₉ are still the binary number of 000000B, but the selection codes S_{0/2/4/ . . . /398}[5:0] respectively received by the selection terminals of all the even analog multiplexers MUX₂, MUX₄, . . . ,MUX₄₀₀ are changed to the binary number of 000001B, which means in the first period, the buffer OPB₁ would drive the pixels of all the odd lines in the LCD panel (not shown), while the buffer OPB₂ would drive the pixels of all the even lines of the LCD panel.

Since the control signal CS provided by the control signal generating unit 403 is disabled in the second period, therefore, the selection codes S_{0/1/2/ . . . /399}[5:0] respectively received by the selection terminals of all the analog multiplexers MUX₁-MUX₄₀₀ are the binary number of 000000B, which enables the buffer OPB₁ to drive all the pixels in the LCD panel in the second period.

Accordingly, assuming all the analog multiplexers MUX₁-MUX₄₀₀ select a same driving voltage V[1] for outputting, at the time, the selection terminals of the analog multiplexers MUX₁-MUX₄₀₀ should respectively receive a binary number of 000001B of the selection codes S_{0/1/2/ . . . /399}[5:0] respectively provided by the latches LH₁-LH₄₀₀. However, since the control signal CS provided by the control signal generating unit 403 is enabled in the first period, therefore, the selection codes S_{0/2/4/ . . . /398}[5:0] respectively received by the selection terminals of all the odd analog multiplexers MUX₁, MUX₃, . . . ,MUX₃₉₉ are changed to the binary number of 000000B, but the selection codes S_{0/2/4/ . . . /398}[5:0] respectively received by the selection terminals of all the even analog multiplexers MUX₂, MUX₄, . . . ,MUX₄₀₀ are still the binary number of 000001B, which means in the first period, the buffer OPB₁ would drive the pixels of all the odd lines in the LCD panel, while the buffer OPB₂ would drive the pixels of all the even lines of the LCD panel.

Since the control signal CS provided by the control signal generating unit 403 is disabled in the second period, therefore, the selection codes S_{0/1/2/ . . . /399}[5:0] respectively received by the selection terminals of all the analog multiplexers MUX₁-MUX₄₀₀ are the binary number of 000001B, which enables the buffer OPB₂ to drive all the pixels in the LCD panel in the second period.

In addition, in the third embodiment, assuming all the analog multiplexers MUX₁-MUX₄₀₀ select other buffered driving voltage for outputting, for example, V[2]/V[3]/ . . . /V[63] for outputting, the corresponding operation is the same as the above-mentioned situation where the driving voltage V[0] is output, which should be easily deducted by anyone skilled in the art with referring to the instruction of the third embodiment and is omitted for simplicity herein.

Note that when the number of the analog multiplexers to drive a same gray level exceeds the number of pixels which a single buffer is competent for driving, the source driving apparatus 400 of the present invention uses two buffers therein to respectively drive two parts of channels of the LCD panel in the first period, wherein all the channels of the two parts are corresponding to the gray level, while in the second period, only a single buffer is used to drive all the channels of the two parts of the LCD panel corresponding to the gray level.

Consequently, even the total channel number of the source driving apparatus 400 of the third embodiment is double of the total channel number of the conventional source driving apparatus 100, the source driving apparatus 400 is competent for driving all the pixels in the LCD panel without enhancing the driving capabilities of the buffers OPB₁-OPB₆₄ therein.

Similarly, the numbers of the employed analog multiplexers and the number of the employed latches respectively required by the source driving apparatus 400 and the control unit thereof must follow the total channel number of the source driving apparatus 400, while the number of employed the resistors and the buffers and the number of the employed connection lines in the control unit mainly depend on the gray level resolution of the source driving apparatus 400, which should be easily deducted by anyone skilled in the art and omitted herein for simplicity.

On the other hand, the above-mentioned source driving apparatus 400 of the third embodiment is, not limiting the present invention, one of embodiments of the present invention. ln other embodiments of the present invention, the source driving apparatus 400 may employ two or more buffers therein so as to respectively drive the pixels of the LCD panel in the first period, and then use a single buffer to drive all the pixels in the LCD panel.

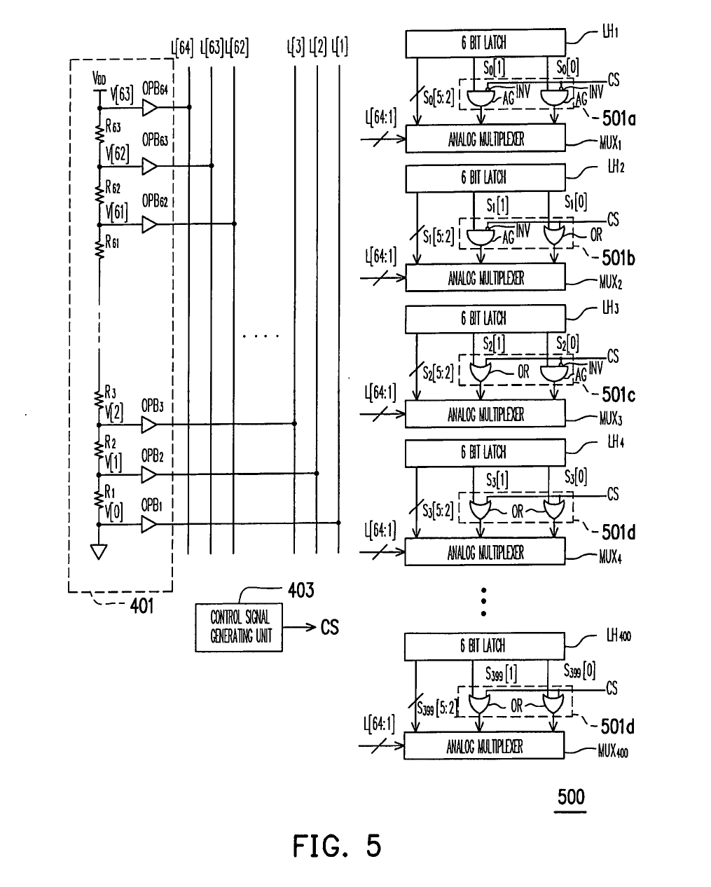

FIG. 5 is a circuit diagram of a source driving apparatus 500 according to the fourth embodiment of the present invention. Referring to FIG. 5, the electrical connections, the operation and the function for the components in the source driving apparatus 500 are almost same as that of the source driving apparatus 400, except the control unit of the source driving apparatus 500 has a first group, a second group, a third group and a fourth group of digital processing units 501a-501d, wherein each the group has 100 digital processing units.

In the fourth embodiment, the first digital processing units 501a are respectively coupled to the selection terminals of the analog multiplexers MUX₁, MUX₅, . . . ,MUX₃₉₇ (i.e. the (4m+1)-th analog multiplexers among the analog multiplexers MUX₁-MUX₄₀₀, wherein m is a positive integer) for deciding whether or not to change the LSB S_{0/4/8/ . . . /396}[0] or the sub-LSB S_{0/4/8/ . . . /396}[l] of the selection codes S_{0/4/8/ . . . /396}[5:0] respectively received by the selection terminals of the analog multiplexers MUX₁, MUX₅, . . . ,MUX₃₉₇ in the first period according to a control signal CS provided by the control signal generating unit 403.

The second digital processing units 501b are respectively coupled to the selection terminals of the analog multiplexers MUX₂, MUX₆, . . . ,MUX₃₉₈ (i.e. the (4m+2)-th analog multiplexers among the analog multiplexers MUX₁-MUX₄₀₀, wherein m is a positive integer) for deciding whether or not to change the LSB S_{1/5/9/ . . . /397}[0] or the sub-LSB S_{1/5/9/ . . . /397}[1] of the selection codes S_{1/5/9/ . . . /397}[5:0] respectively received by the selection terminals of the analog multiplexers MUX₂, MUX₆, . . . ,MUX₃₉₈ in the first period according to a control signal CS provided by the control signal generating unit 403.

The third digital processing units 501c are respectively coupled to the selection terminals of the analog multiplexers MUX₃, MUX₇, . . . ,MUX₃₉₉ (i.e. the (4m+3)-th analog multiplexers among the analog multiplexers MUX₁-MUX₄₀₀, wherein m is a positive integer) for deciding whether or not to change the LSB S_{2/6/10/ . . . /398}[0] or the sub-LSB S_{2/6/10/ . . . /398}[1] of the selection codes S_{2/6/10/ . . . /398}[5:0] respectively received by the selection terminals of the analog multiplexers MUX₃, MUX₇, . . . ,MUX₃₉₉ in the first period according to a control signal CS provided by the control signal generating unit 403.

The fourth digital processing units 501d are respectively coupled to the selection terminals of the analog multiplexers MUX₄, MUX₈, . . . ,MUX₄₀₀ (i.e. the (4m+4)-th analog multiplexers among the analog multiplexers MUX₁-MUX₄₀₀, wherein m is a positive integer) for deciding whether or not to change the LSB S_{3/7/11/ . . . /399}[0] or the sub-LSB S_{3/7/11/ . . . /399}[l] of the selection codes S_{3/7/11/ . . . /399}[5:0] respectively received by the selection terminals of the analog multiplexers MUX₄, MUX₈, . . . ,MUX₄₀₀ in the first period according to a control signal CS provided by the control signal generating unit 403.

It can be clearly seen form FIG. 5, each of the first digital processing units 501a mainly includes two AND-gates AG and two NOT-gates INV, while each of the second digital processing units 501b and each of the third digital processing units 501c mainly respectively include an OR-gate OR, an AND-gate AG and a NOT-gate INV, and each of the fourth digital processing units 501d mainly includes two OR-gates OR; the wiring thereof can be referred to FIG. 5 and omitted herein for simplicity.

Accordingly, assuming all the analog multiplexers MUX₁-MUX₄₀₀ select a same driving voltage V[0] for outputting, at the time, the selection terminals of the analog multiplexers MUX₁-MUX₄₀₀ should respectively receive a binary number of 000000B of the selection codes S_{1/2/3/ . . . . /399}[5:0] respectively provided by the latches LH₁-LH₄₀₀. However, since the control signal CS provided by the control signal generating unit 403 is enabled in the first period, therefore, the selection codes S_{0/4/8/ . . . /396}[5:0] respectively received by the selection terminals of the analog multiplexers MUX₁, . . . ,MUX₃₉₇ are still the binary number of 000000B, but the selection codes S_{1/5/9/ . . . /397}[5:0] respectively received by the selection terminals of the analog multiplexers MUX₂, MUX₆, . . . ,MUX₃₉₈ are changed to the binary number of 000001B.

In addition, the selection codes S_{2/6/10/ . . . /398}[5:0] respectively received by the selection terminals of the analog multiplexers MUX₃, MUX₇, . . . MUX₃₉₉ are changed to the binary number of 000010B, while the selection codes S_{3/7/11/ . . . /399}[5:0] respectively received by the selection terminals of the analog multiplexers MUX₄, MUX₈, . . . ,MUX₄₀₀ are changed to the binary number of 000011B, which means in the first period, all the pixels in the LCD panel (not shown) are driven by the buffers OPB₁-OPB₄.

Since the control signal CS provided by the control signal generating unit 403 is disabled in the second period, therefore, the selection codes S_{0/1/2/ . . . /399}[5:0] respectively received by the selection terminals of all the analog multiplexers MUX₁-MUX₄₀₀ are the binary number of 000000B, which enables the buffer OPB₁ to drive all the pixels in the LCD panel in the second period.

Similarly, assuming all the analog multiplexers MUX₁-MUX₄₀₀ select a same driving voltage V[0] for outputting, at the time, the selection terminals of the analog multiplexers MUX₁-MUX₄₀₀ should respectively receive a binary number of 000001B of the selection codes S_{0/1/2/ . . . /399}[5:0] respectively provided by the latches LH₁-LH₄₀₀. However, since the control signal CS provided by the control signal generating unit 403 is enabled in the first period, therefore, the selection codes S_{0/4/8/ . . . /396}[5:0] respectively received by the selection terminals of the analog multiplexers MUX₁, MUX₅, . . . ,MUX₃₉₇ are changed to the binary number of 000000B, but the selection codes S_{1/5/9/ . . . /397}[5:0] respectively received by the selection terminals of the analog multiplexers MUX₂, MUX₆, . . . ,MUX₃₉₈ still are the binary number of 000001B.

In addition, the selection codes S_{2/6/10/ . . . /398}[5:0] respectively received by the selection terminals of the analog multiplexers MUX₃, MUX₇, . . . /MUX₃₉₉ are changed to the binary number of 000010B, while the selection codes S_{3/7/11/ . . . /398}[5:0] respectively received by the selection terminals of the analog multiplexers MUX₄, MUX₈, . . . ,MUX₄₀₀ are changed to the binary number of 000011B, which means in the first period, all the pixels in the LCD panel (not shown) are driven by the buffers OPB₁-OPB₄.

Then, since the control signal CS provided by the control signal generating unit 403 is disabled in the second period, therefore, the selection codes S_{1/1/2/ . . . /399}[5:0] respectively received by the selection terminals of all the analog multiplexers MUX₁-MUX₄₀₀ are the binary number of 000001B, which enables the buffer OPB₂ to drive all the pixels in the LCD panel in the second period.

Similarly, assuming all the analog multiplexers MUX₁-MUX₄₀₀ select a same driving voltage V[2] for outputting, at the time, the selection terminals of the analog multiplexers MUX₁-MUX₄₀₀ should respectively receive a binary number of 000010B of the selection codes S_{0/1/2/ . . . /399}[5:0] respectively provided by the latches LH₁-LH₄₀₀. However, since the control signal CS provided by the control signal generating unit 403 is enabled in the first period, therefore, the selection codes S_{0/4/8/ . . . /396}[5:0] respectively received by the selection terminals of the analog multiplexers MUX₁, MUX₅, . . . ,MUX₃₉₇ are changed to the binary number of 000000B, but the selection codes S_{1/5/9/ . . . /397}[5:0] respectively received by the selection terminals of the analog multiplexers MUX₂, MUX₆, . . . ,MUX₃₉₈ would be changed to the binary number of 000001B.

In addition, the selection codes S_{2/6/10/ . . . /398}[5:0] respectively received by the selection terminals of the analog multiplexers MUX₃, MUX₇, . . . ,MUX₃₉₉ are still the binary number of 000010B, while the selection codes S_{3/7/11/ . . . /399}[5:0] respectively received by the selection terminals of the analog multiplexers MUX₄, MUX₈, . . , are changed to the binary number of 000011B, which means in the first period, all the pixels in the LCD panel are still driven by the buffers OPB₁-OPB₄.

After that, since the control signal CS provided by the control signal generating unit 403 is disabled in the second period, therefore, the selection codes S_{0/1/2/ . . . /399}[5:0] respectively received by the selection terminals of all the analog multiplexers MUX₁-MUX₄₀₀ are the binary number of 000010B, which enables the buffer OPB₃ to drive all the pixels in the LCD panel in the second period.

Further, assuming all the analog multiplexers MUX₁-MUX₄₀₀ select a same driving voltage V[3] for outputting, at the time, the selection terminals of the analog multiplexers MUX₁-MUX₄₀₀ should respectively receive a binary number of 000011B of the selection codes S_{0/1/2/ . . . /399}[5:0] respectively provided by the latches LH₁-LH₄₀₀. However, since the control signal CS provided by the control signal generating unit 403 is enabled in the first period, therefore, the selection codes S_{0/4/8/ . . . /396}[5:0] respectively received by the selection terminals of the analog multiplexers MUX₁, MUX₅, . . . ,MuX₃₉₇ are changed to the binary number of 000000B, but the selection codes S_{1/5/9/ . . . /397}[5:0] respectively received by the selection terminals of the analog multiplexers MUX₂, MUX₆, . . . ,MUX₃₉₈ would be changed to the binary number of 000001B.

In addition, the selection codes S_{2/6/10/ . . . ,/398}[5:0] respectively received by the selection terminals of the analog multiplexers MUX₃, MUX₇, . . . ,MUX₃₉₉ are changed to the binary number of 000010B, while the selection codes S_{3/7/11/ . . . /399}[5:0] respectively received by the selection terminals of the analog multiplexers MUX₄, MUX₈, . . . ,MUX₄₀₀ are still the binary number of 000011B, which means in the first period, all the pixels in the LCD panel are still driven by the buffers OPB₁-OPB₄.

Furthermore, since the control signal CS provided by the control signal generating unit 403 is disabled in the second period, therefore, the selection codes S_{0/1/2/ . . . /399}[5:0] respectively received by the selection terminals of all the analog multiplexers MUX₁-MUX₄₀₀ are the binary number of 000011B, which enables the buffer OPB₄ to drive all the pixels in the LCD panel in the second period.

Note that when the number of the analog multiplexers to drive a same gray level exceeds the number of pixels which a single buffer is competent for driving, the source driving apparatus 500 of the present invention uses four buffers therein to respectively drive parts of channels of the LCD panel in the first period, wherein all the channels of all the parts are corresponding to the gray level, while in the second period, only a single buffer is used to drive all the channels of all the parts of the LCD panel corresponding to the gray level.

In addition, in the fourth embodiment, assuming all the analog multiplexers MUX₁-MUX₄₀₀ select other buffered driving voltage for outputting, for example, V[4]/V[5]/ . . . /V[63] for outputting, the corresponding operation is the same as the above-mentioned situation where the driving voltages V[0]-V[3] are output, which should be easily deducted by anyone skilled in the art with referring to the instruction of the fourth embodiment and is omitted for simplicity herein.

Consequently, even the total channel number of the source driving apparatus 500 of the fourth embodiment is double of the total channel number of the conventional source driving apparatus 100, the source driving apparatus 500 is still competent for driving all the pixels in the LCD panel without enhancing the driving capabilities of the buffers OPB₁-OPB₆₄ therein.

Similarly, the number of the analog multiplexers and the number of the latches respectively required by the source driving apparatus 500 and the control unit thereof must follow the total channel number of the source driving apparatus 500, while the numbers of employed the resistors and the buffers and the number of the employed connection lines in the control unit mainly depend on the gray level resolution of the source driving apparatus 500, which should be easily deducted by anyone skilled in the art and omitted herein for simplicity.

According to the above described, the source driving apparatuses 400 and 500 respectively provided by the third embodiment and the fourth embodiment mainly use the digital processing units of the control unit therein to change the states of the selection codes S_{0/1/2/ . . . /399}[5:0] at the selection terminals of the analog multiplexers MUX₁-MUX₄₀₀ provided by the latches LH₁-LH₄₀₀, so that the source driving apparatuses 400 and 500 are capable enough of driving all pixels in an LCD panel without extremely enhancing the driving capability of the buffers therein to suit an increasing total channel number thereof.

Moreover, although in the third and the fourth embodiments the operations are based on changing the LSB and the sub-LSB of the selection codes S_{0/1/2/ . . . /399}[5:0], but it does not mean the present invention is limited thereto. As a matter of fact, a user is allowed to change over two significant-bits in the selection codes S_{0/1/2/ . . . /399}[5:0] and use an appropriate design of the digital processing units in response to the states of the selection codes S_{0/1/2/ . . . /399}[5:0] to achieve the goals of the present invention, which still falls within the claimed scope of the present invention.

In summary, any of the source driving apparatuses provided by the present invention is applicable to an LCD today to gain the advantage that the provided source driving apparatus is capable enough of driving all pixels in the LCD panel without extremely enhancing the driving capability of the buffers therein to suit an increasing total channel number thereof so as to adapt the higher and higher resolution of the LCD panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driving apparatus, comprising:
a driving voltage generating unit, for providing N driving voltage levels, wherein N is a positive integer;
a plurality of analog multiplexers, coupled to the driving voltage generating unit and having a first group of analog multiplexers and a second group of analog multiplexers, and each of the analog multiplexers having a plurality of input terminals for correspondingly receiving the driving voltage levels, at least a selection terminal and an output terminal, wherein each of the analog multiplexers selects and uses the output terminal thereof to output one of the driving voltage levels according to a selection code received by the selection terminal thereof; and
a control unit, coupled to the analog multiplexers, wherein when both at least an analog multiplexer in the first group and at least an analog multiplexer in the second group select a first driving voltage level, the control unit controls at least the analog multiplexer in the first group and at least the analog multiplexer in the second group to respectively output different driving voltage levels in a first period, and then controls at least the analog multiplexer in the first group and at least the analog multiplexer in the second group to simultaneously output the first driving voltage level in a second period.

2. The source driving apparatus according to claim 1, wherein the driving voltage generating unit comprises:
(N−1) resistors, coupled in series each other, and coupled between a system voltage and a reference level for dividing a level difference between the system voltage and the reference level to generate the N driving voltage levels.

3. The source driving apparatus according to claim 2, wherein the driving voltage generating unit further comprises:
N buffers, for respectively buffering the N driving voltage levels and then outputting the buffered driving voltage levels to the input terminals of the analog multiplexers.

4. The source driving apparatus according to claim 3, wherein when both at least the analog multiplexer in the first group and at least the analog multiplexer in the second group select the first driving voltage level in the first period, the control unit changes the selection code, originally corresponding to the first driving voltage level and received by the selection terminal of at least the analog multiplexer in the first group, to make the selection code corresponding to a second driving voltage level so that at least the analog multiplexer in the first group selects the second driving voltage level, while at least the analog multiplexer in the second group still selects the first driving voltage level; and then in the second period, the control unit reinstates the selection code received by the selection terminals of at least the analog multiplexers in the first group so that at least the analog multiplexers in the first group and the second group simultaneously select the first driving voltage level.

5. The source driving apparatus according to claim 4, wherein the control unit changes a least-significant-bit (LSB) of the selection code corresponding to the first driving voltage level to make the changed selection code corresponding to the second driving voltage level in the first period.

6. The source driving apparatus according to claim 5, wherein the control unit comprises:
a plurality of first digital processing units, respectively coupled to at least the analog multiplexer in the first group, for in the first period deciding whether or not to change the LSB of the selection code received by the selection terminal of at least the analog multiplexer in the first group and originally corresponding to the first driving voltage level according to a control signal; and
a plurality of second digital processing units, respectively coupled to at least the analog multiplexer in the second group, for in the first period deciding whether or not to change the LSB of the selection code received by the selection terminal of at least the analog multiplexer in the second group and originally corresponding to the first driving voltage level according to the control signal.

7. The source driving apparatus according to claim 6, wherein each of the first digital processing units comprises:
an AND-gate, having two input terminals and an output terminal, wherein one of the input terminals of the AND-gate is used for receiving the LSB of the selection code corresponding to the first driving voltage level; and
an NOT-gate, for receiving the control signal and outputting the inverted control signal to another input terminal of the AND-gate,
wherein when the control signal is enabled, the output terminal of the AND-gate outputs a low logic level; when the control signal is disabled, the output terminal of the AND-gate outputs the LSB of the selection code corresponding to the first driving voltage level.

8. The source driving apparatus according to claim 6, wherein each of the second digital processing units comprises:
an OR-gate, having two input terminals and an output terminal, wherein one of the input terminals of the OR-gate is used for receiving the LSB of the selection code corresponding to the first driving voltage level, while another input terminal of the OR-gate is used for receiving the control signal,
wherein when the control signal is enabled, the output terminal of the OR-gate outputs a high logic level; when the control signal is disabled, the output terminal of the OR-gate outputs the LSB of the selection code corresponding to the first driving voltage level.

9. The source driving apparatus according to claim 6, wherein the control unit further comprises:
a control signal generating unit, coupled to the first digital processing units and the second digital processing units, for providing the control signal.

10. The source driving apparatus according to claim 6, wherein the control unit further comprises:
a plurality of connection lines, respectively coupled to the input terminals of the analog multiplexers, for correspondingly receiving the buffered driving voltage levels; and
a plurality of latches, respectively coupled to the selection terminals of the analog multiplexers, for providing the selection code.

11. The source driving apparatus according to claim 3, wherein the analog multiplexers further have a third group of analog multiplexers and a fourth group of analog multiplexers.

12. The source driving apparatus according to claim 11, wherein when all at least an analog multiplexers in the first group, at least an analog multiplexers in the second group, at least an analog multiplexers in the third group and at least an analog multiplexers in the fourth group select the first driving voltage level, the control unit in the first period makes at least the analog multiplexer in the first group, at least the analog multiplexer in the second group, at least the analog multiplexer in the third group and at least the analog multiplexer in the fourth group respectively output four different voltage levels, and then the control unit in the second period makes at least the analog multiplexer in the first group, at least the analog multiplexer in the second group, at least the analog multiplexer in the third group and at least the analog multiplexer in the fourth group simultaneously output the first driving voltage level.

13. The source driving apparatus according to claim 12, wherein when all at least the analog multiplexer in the first group, at least the analog multiplexer in the second group, at least the analog multiplexer in the third group and at least the analog multiplexer in the fourth group select the first driving voltage level, the control unit in the first period changes three selection codes among four selections codes, corresponding to the first voltage level and respectively received by the selection terminals of at least the analog multiplexer in the first group, at least the analog multiplexer in the second group, at least the analog multiplexer in the third group and at least the analog multiplexer in the fourth group, so that three analog multiplexers with the changed selection code among at least the analog multiplexer in the first group, at least the analog multiplexer in the second group, at least the analog multiplexer in the third group and at least the analog multiplexer in the fourth group respectively select a second driving voltage level, a third driving voltage level, and a fourth driving voltage level, wherein the second through the fourth driving voltage levels are different from the first driving voltage level, while one analog multiplexer without the changed selection code among at least the analog multiplexer in the first group, at least the analog multiplexer in the second group, at least the analog multiplexer in the third group and at least the analog multiplexer in the fourth group still select the first driving voltage level; and then in the second period, the control unit reinstates the selection codes respectively received by the selection terminals of at least the analog multiplexer in the first group, at least the analog multiplexer in the second group, at least the analog multiplexer in the third group and at least the analog multiplexer in the fourth group, so that at least the analog multiplexers in the first group, the second group, the third group and the fourth group simultaneously select the first driving voltage level.

14. The source driving apparatus according to claim 13, wherein the control unit changes a least-significant-bit (LSB) and a sub-least-significant-bit (sub-LSB) of the selection code originally corresponding to the first driving voltage level in the first period.

15. The source driving apparatus according to claim 14, wherein the control unit comprises:
a plurality of first digital processing units, respectively coupled to at least the analog multiplexer in the first group, for in the first period deciding whether or not to change the LSB and the sub-LSB of the selection code received by the selection terminal of at least the analog multiplexer in the first group and originally corresponding to the first driving voltage level according to a control signal;
a plurality of second digital processing units, respectively coupled to at least the analog multiplexer in the second group, for in the first period deciding whether or not to change the LSB and the sub-LSB of the selection code received by the selection terminal of at least the analog multiplexer in the second group and originally corresponding to the first driving voltage level according to the control signal;
a plurality of third digital processing units, respectively coupled to at least the analog multiplexer in the third group, for in the first period deciding whether or not to change the LSB and the sub-LSB of the selection code received by the selection terminal of at least the analog multiplexer in the third group and originally corresponding to the first driving voltage level according to the control signal; and
a plurality of fourth digital processing units, respectively coupled to at least the analog multiplexer in the fourth group, for in the first period deciding whether or not to change the LSB and the sub-LSB of the selection code received by the selection terminal of at least the analog multiplexer in the fourth group and originally corresponding to the first driving voltage level according to the control signal.

16. The source driving apparatus according to claim 15, wherein each of the first digital processing units comprises:
a first AND-gate, having two input terminals and an output terminal, wherein one of the input terminals of the first AND-gate is used for receiving the LSB of the selection code corresponding to the first driving voltage level;
a second AND-gate, having two input terminals and an output terminal, wherein one of the input terminals of the second AND-gate is used for receiving the sub-LSB of the selection code corresponding to the first driving voltage level; and
a first NOT-gate and a second NOT-gate, for receiving the control signal and respectively outputting the inverted control signals to another input terminals of the first AND-gate and the second AND-gate,
wherein when the control signal is enabled, the output terminals of the first AND-gate and the second AND-gate respectively output a low logic level; when the control signal is disabled, the output terminals of the first AND-gate and the second AND-gate respectively output the LSB and the sub-LSB of the selection code corresponding to the first driving voltage level.

17. The source driving apparatus according to claim 15, wherein each of the second digital processing units comprises:
an OR-gate, having two input terminals and an output terminal, wherein one of the input terminals of the OR-gate is used for receiving the LSB of the selection code corresponding to the first driving voltage level, while another input terminal of the OR-gate is used for receiving the control signal;
an AND-gate, having two input terminals and an output terminal, wherein one of the input terminals of the AND-gate is used for receiving the sub-LSB of the selection code corresponding to the first driving voltage level; and
an NOT-gate, for receiving the control signal and outputting the inverted control signal to another input terminal of the AND-gate,
wherein when the control signal is enabled, the output terminals of the OR-gate and the AND-gate respectively output a high logic level and a low logic level; when the control signal is disabled, the output terminals of the OR-gate and the AND-gate respectively output the LSB and the sub-LSB of the selection code corresponding to the first driving voltage level.

18. The source driving apparatus according to claim 15, wherein each of the third digital processing units comprises:
an AND-gate, having two input terminals and an output terminal, wherein one of the input terminals of the AND-gate is used for receiving the LSB of the selection code corresponding to the first driving voltage level;
an OR-gate, having two input terminals and an output terminal, wherein one of the input terminals of the OR-gate is used for receiving the sub-LSB of the selection code corresponding to the first driving voltage level, while another input terminal of the OR-gate is used for receiving the control signal; and
an NOT-gate, for receiving the control signal and outputting the inverted control signal to another input terminal of the AND-gate,
wherein when the control signal is enabled, the output terminals of the AND-gate and the OR-gate respectively output a low logic level and a high logic level; when the control signal is disabled, the output terminals of the AND-gate and the OR-gate respectively output the LSB and the sub-LSB of the selection code corresponding to the first driving voltage level.

19. The source driving apparatus according to claim 15, wherein each of the fourth digital processing units comprises:
a first OR-gate, having two input terminals and an output terminal, wherein one of the input terminals of the first OR-gate is used for receiving the LSB of the selection code corresponding to the first driving voltage level and another input terminal of the first OR-gate is used for receiving the control signal; and
a second OR-gate, having two input terminals and an output terminal, wherein one of the input terminals of the second OR-gate is used for receiving the sub-LSB of the selection code corresponding to the first driving voltage level and another input terminal of the second OR-gate is used for receiving the control signal,
wherein when the control signal is enabled, the output terminals of the first OR-gate and the second OR-gate respectively output a high logic level; when the control signal is disabled, the output terminals of the first OR-gate and the second OR-gate respectively output the LSB and the sub-LSB of the selection code corresponding to the first driving voltage level.

20. The source driving apparatus according to claim 15, wherein the control unit further comprises:
a plurality of connection lines, respectively coupled to the input terminals of the analog multiplexers, for correspondingly receiving the buffered driving voltage levels; and
a plurality of latches, respectively coupled to the selection terminals of the analog multiplexers, for providing the selection code.

21. The source driving apparatus according to claim 3, wherein the control unit is further coupled to the buffers and comprises:
N first connection lines, wherein the odd ones of the first connection lines are for correspondingly receiving the driving voltage levels buffered by the odd ones of the buffers and correspondingly coupled to the odd ones of the input terminals of the analog multiplexers in the first group; the even ones of the first connection lines are in floating connection and correspondingly coupled to the even ones of the input terminals of the analog multiplexers in the first group;
N second connection lines, wherein the even ones of the second connection lines are for correspondingly receiving the driving voltage levels buffered by the even ones of the buffers and correspondingly coupled to the even ones of the input terminals of the analog multiplexers in the second group; the odd ones of the second connection lines are floating and correspondingly coupled to the odd ones of the input terminals of the analog multiplexers in the second group;
N first switches, divided into a third group and a fourth group, wherein the first switches of the third group are respectively coupled between the i-th one and the (i+1)-th one of the first connection lines, while the first switches of the fourth group are respectively coupled between the i-th one and the (i+1)-th one of the second connection lines, wherein i is an odd positive integer; and
N second switches, respectively coupled between the j-th one of the first connection lines and the j-th one of the second connection lines, wherein j is a positive integer,
wherein the first switches are turned on in the first period, while the second switches are turned on in the second period.

22. The source driving apparatus according to claim 21, wherein the control unit further comprises:
a plurality of latches, respectively coupled to the selection terminals of the analog multiplexers, for providing the selection codes.

23. The source driving apparatus according to claim 2, wherein the driving voltage generating unit further comprises:
(N+1) buffers, for respectively buffering the driving voltage levels and then outputting the buffered driving voltage levels to the input terminals of the analog multiplexers.

24. The source driving apparatus according to claim 23, wherein the control unit is further coupled to the buffers and comprises:
N first connection lines, wherein the odd ones of the first connection lines are for correspondingly receiving the driving voltage levels buffered by the even ones of the buffers and correspondingly coupled to the odd ones of the input terminals of the analog multiplexers in the first group; the even ones of the first connection lines are floating and correspondingly coupled to the even ones of the input terminals of the analog multiplexers in the first group;
N second connection lines, wherein the first one and the even ones of the second connection lines are for correspondingly receiving the driving voltage levels buffered by the odd ones of the buffers and the even ones of the second connection lines are correspondingly coupled to the even ones of the input terminals of the analog multiplexers in the second group; the first one of the second connection lines is correspondingly coupled to the first input terminals of the analog multiplexers in the second group; the odd ones of the second connection lines without the first one thereof are floating and respectively coupled to the odd ones of the input terminals without the first terminal thereof of the analog multiplexers in the second group;
(N−1) first switches, divided into a third group and a fourth group, wherein the first switches of the third group are respectively coupled between the i-th one and the (i+1)-th one of the first connection lines, while the first switches of the fourth group are respectively coupled between the j-th one and the (j+1)-th one of the second connection lines, wherein i and j are respectively an odd positive integer and a even positive integer; and
N second switches, respectively coupled between the k-th one of the first connection lines and the k-th one of the second connection lines, wherein k is a positive integer,
wherein the first switches are turned on in the first period, and the second switches are turned on in the second period.

25. The source driving apparatus according to claim 24, wherein the control unit further comprises:
a plurality of latches, respectively coupled to the selection terminals of the analog multiplexers, for providing the selection codes.
